(19) United States
(12) Patent Application Publication
(10) Pub. No.: US 2026/0159091 A1
(43) Pub. Date: Jun. 11, 2026

(54) UPDATING MODE PARAMETERS OF A DRIVING MODE BASED ON A SMART DRIVING PROFILE

(71) Applicant: Honda Motor Co., Ltd., Tokyo (JP)

(72) Inventors: Alexander J. WADDELL, Dublin, OH (US); Casey D. MYERS, Marysville, OH (US); Dylan J. MYERS, Marysville, OH (US); Nicholas T. HEYDINGER, Dublin, OH (US); Clayton A. THOMAS, Worthington, OH (US); Nathan B. KIMBLE, Raymond, OH (US)

(21) Appl. No.: 18/973,371

(22) Filed: Dec. 9, 2024

(51) Int. Cl. B60W 30/182; B60W 40/09; B60W 50/00; B60W 50/08; B60W 50/14; G06F 3/04847

(52) U.S. Cl. CPC B60W 30/182; B60W 40/09; B60W 50/082; B60W 50/14; G06F 3/04847; B60W 2050/0083; B60W 2050/146; B60W 2540/10; B60W 2540/12; B60W 2540/18; B60W 2540/215; B60W 2552/05; B60W 2555/20; B60W 2556/10

(57) ABSTRACT

A system for a vehicle is provided to update mode parameters of a vehicle's driving mode. The system is configured to receive sensor information associated with the vehicle and select a driving mode from a plurality of available driving modes. Based on the sensor information, the system determines a driving profile for the selected mode, which is associated with the vehicle's user. The system updates values of mode parameters associated with the selected driving mode based on the driving profile. Using the updated values, at least one electronic control unit (ECU) controls various functional components of the vehicle. Each of the mode parameters include a predetermined range of values, adjustable through settable threshold boundaries, with the updated values constrained to remain within the adjustable range. Additionally, the system includes configurable sensitivity settings that enable the user to adjust how responsive the mode parameters are to changes in sensor information.

### BACKGROUND

Integrated dynamic systems (IDS) provide users with valuable insights into various vehicle parameters, including but not limited to engine speed, suspension, and steering configurations. Despite their benefits, these systems exhibit limitations in enabling alterations to the driving experience. Although users may select predefined modes such as comfort, sport, or normal to accommodate particular driving scenarios, these modes are constrained by a static understanding of vehicle dynamics and fail to account for evolving driving patterns or user preferences. Existing IDS systems typically rely on predetermined parameters that, while convenient, offer little opportunity for customization or integration of machine-learned adaptations based on real-time data or historical driving behaviors. This lack of flexibility can be frustrating for drivers seeking a more personalized driving experience that dynamically adjusts to their driving style. The challenge in the automotive industry lies in striking a balance between user-friendly preset modes and more advanced, customizable options, such as those driven by data-driven algorithms or machine learning techniques. The limitations and disadvantages of such conventional systems will become apparent when compared to various aspects of the present disclosure, as detailed further in this application and with reference to the accompanying figures.

### BRIEF DESCRIPTION

According to one aspect, a system includes control circuitry configured to: receive sensor information including operational parameters associated with a vehicle and ambient information associated with an environment outside the vehicle; select a driving mode from a plurality of driving modes associated with the vehicle; determine a driving profile in the selected driving mode associated with a user of the vehicle based on the sensor information; update values of mode parameters associated with the selected driving mode based on the driving profile; and control, via at least one electronic control unit (ECU) of the vehicle, a plurality of functional components of the vehicle based on the updated values. Each of the mode parameters has a predetermined range of values, the range of values being adjustable via a settable lower threshold and a settable upper threshold. The updated values for each of the mode parameters are constrained to remain within bounds of the lower threshold and the upper threshold.

According to another aspect, a method in a system associated with a vehicle includes: receiving sensor information including operational parameters associated with a vehicle and ambient information associated with an environment outside the vehicle; selecting a driving mode from a plurality of driving modes associated with the vehicle; determining a driving profile in the selected driving mode associated with a user of the vehicle based on the sensor information; updating values of mode parameters associated with the selected driving mode based on the driving profile; and controlling, via at least one electronic control unit (ECU) of the vehicle, a plurality of functional components of the vehicle based on the updated values. Each of the mode parameters has a predetermined range of values, the range of values being adjustable via a settable lower threshold and a settable upper threshold. The updated values for each of the mode parameters are constrained to remain within bounds of the lower threshold and the upper threshold.

According to yet another aspect, a non-transitory computer-readable medium having stored thereon, computer-executable instructions which, when executed by a system associated with a vehicle, cause the system to execute operations, the operations including: receiving sensor information including operational parameters associated with a vehicle and ambient information associated with an environment outside the vehicle; selecting a driving mode from a plurality of driving modes associated with the vehicle; determining a driving profile in the selected driving mode associated with a user of the vehicle based on the sensor information; updating values of mode parameters associated with the selected driving mode based on the driving profile; and controlling, via at least one electronic control unit (ECU) of the vehicle, a plurality of functional components of the vehicle based on the updated values. Each of the mode parameters has a predetermined range of values, the range of values being adjustable via a settable lower threshold and a settable upper threshold. The updated values for each of the mode parameters are constrained to remain within bounds of the lower threshold and the upper threshold.

### BRIEF DESCRIPTION OF THE DRAWINGS

FIG. 1 is a diagram that illustrates an exemplary environment for updating values of mode parameters of a driving mode of a vehicle, in accordance with an embodiment of the disclosure.

FIG. 2 is a diagram that illustrates an exemplary vehicle system for updating values of mode parameters of a driving mode based on a learnable driving profile of the vehicle, in accordance with an embodiment of the disclosure.

FIG. 3 is a diagram that illustrates an exemplary sequence of operations to update values of mode parameters of a driving mode of a vehicle, in accordance with an embodiment of the disclosure.

FIGS. 4A and 4B are diagrams that collectively illustrate a graphic user interface (GUI) of a display device associated with a vehicle, in accordance with an embodiment of the disclosure.

FIG. 5 is an exemplary scenario diagram that illustrates a change from a preset driving mode to a SMART driving mode, in accordance with an embodiment of the disclosure.

FIG. 6 is an exemplary scenario diagram that illustrates an update in mode parameters in a SMART driving mode at different time instants, in accordance with an embodiment of the disclosure.

FIGS. 7A and 7B are diagrams that collectively illustrate an exemplary scenario for updating values of mode parameters based on a winding road condition, in accordance with an embodiment of the disclosure.

FIGS. 8A and 8B are diagrams that collectively illustrate an exemplary scenario for updating values of mode parameters based on a steady drive condition, in accordance with an embodiment of the disclosure.

FIG. 9 is a flowchart that illustrates an exemplary method of updating values of mode parameters of a driving mode of a vehicle, in accordance with an embodiment of the disclosure.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle or ego-vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pre-tensioning system, a monitoring system, a passenger detection system, a vehicle suspension system, a vehicle seat configuration system, a vehicle cabin lighting system, an audio system, a sensory system, among others.

An “agent”, as used herein, may be a machine that moves through or manipulates an environment. Exemplary agents may include robots, vehicles, or other self-propelled machines. The agent may be autonomously, semi-autonomously, or manually operated.

Various embodiments of the present disclosure may be found in a system for a vehicle. The disclosed system includes control circuitry which may be configured to receive sensor information that may capture operational parameters associated with the vehicle. The operational parameters may be indicative of a driving style (e.g., a level of braking, an acceleration pattern, a steering angle, a suspension feel, and the like.) associated with a user (i.e., a driver/occupant of the vehicle). The sensor information may further capture ambient information associated with an environment outside the vehicle. The ambient information may be indicative of external factors (e.g., weather, road condition, terrain type, and the like) affecting the movement of the vehicle. Based on the sensor information, the control circuitry may determine a driving profile associated with the user. The driving profile may be determined within a selected driving mode or be used to select a driving mode associated with the vehicle. The driving profile may be used to update values of mode parameters associated with the selected driving mode. Thereafter, the control circuitry may control a plurality of functional components (e.g., an acceleration pedal, a brake pedal, a suspension system, a steering system, and the like) of the vehicle, based on the updated values of the mode parameters, via at least one electronic control unit (ECU) of the vehicle.

Traditionally, when an in-vehicle integrated dynamic system (IDS) switches from one driving mode to another, as selected by the user (e.g., the user switches from a sport mode to a comfort mode), the full set of mode parameters is modified. For example, if the user is driving the car on a long highway, the user may select comfort mode. Thereafter, the IDS may alter mode parameter values that are appropriate for the comfort mode. Each of the mode parameters, including but not limited to acceleration, steering, suspension, and regenerative braking, may be changed in accordance with the comfort mode.

Here, the proposed system determines, in near real time, values for the mode parameters based on the user's driving style and influence of an environmental condition (learned from the sensor information), or a combination thereof. For example, the user can select a SMART Mode as the selected driving mode, where the system proactively learns the user's driving style to determine the driving profile associated with the user. The system may be configured to set a user adjustable time period over which the driving profile is determined. Based on the driving profile, the system may identify that the user is attempting to accelerate more often than expected. As a result, the system, while in the SMART Mode, may adjust the value of the acceleration response to correspond with a value associated with the sport mode. In the SMART Mode, the other mode parameters (such as steering, suspension, or regenerative braking) may retain values associated with the comfort mode, while the system allows for a more responsive acceleration pedal, similar to that in sport mode.

For example, in the SMART Mode, the system may suggest a steering angle adjustment, enabling the user to steer the electric power steering system with enhanced feel, taking road conditions into account, while keeping other mode parameters (e.g., Acceleration, Suspension, or Regenerative Braking) with values associated with the normal mode. Even if the user is unable to define their preferred driving style, the system learns and adapts, providing a user-desired driving experience by dynamically adjusting the values of the mode parameters (in near real-time), with each parameter being adjusted respectively, and controlling various functional components of the vehicle in real-time or near real-time.

Furthermore, in the SMART Mode, the values for adjustment for each mode parameter may be defined by a range of values. This predetermined range of values allows the user to understand how a corresponding functional component of the system is being adjusted and into what mode the value is associated - whether it is comfort mode, normal mode, or sport mode. The range of values is configured to have a predetermined range, and the range may be adjustable by the user via a settable lower threshold and a settable upper threshold. The adjusted values associated with each mode parameter may then be constrained to remain within the bounds of the lower threshold and upper threshold set by the user. In this way, in the SMART Mode, the system more likely avoids adjustments to the mode parameters that are undesirable for the user or outside of their preferences at that time.

In the SMART Mode, adjusting and updating values of the mode parameters may be initiated based on at least sensitivity settings that define trigger thresholds for adjustments to the mode parameters triggered by the sensor information. The sensitivity settings may be associated with the driving profile, and the sensitivity settings may be user configurable.

Reference will now be made in detail to specific aspects or features, examples of which are illustrated in the accompanying drawings. Wherever possible, corresponding, or similar reference numbers will be used throughout the drawings to refer to the same or corresponding parts.

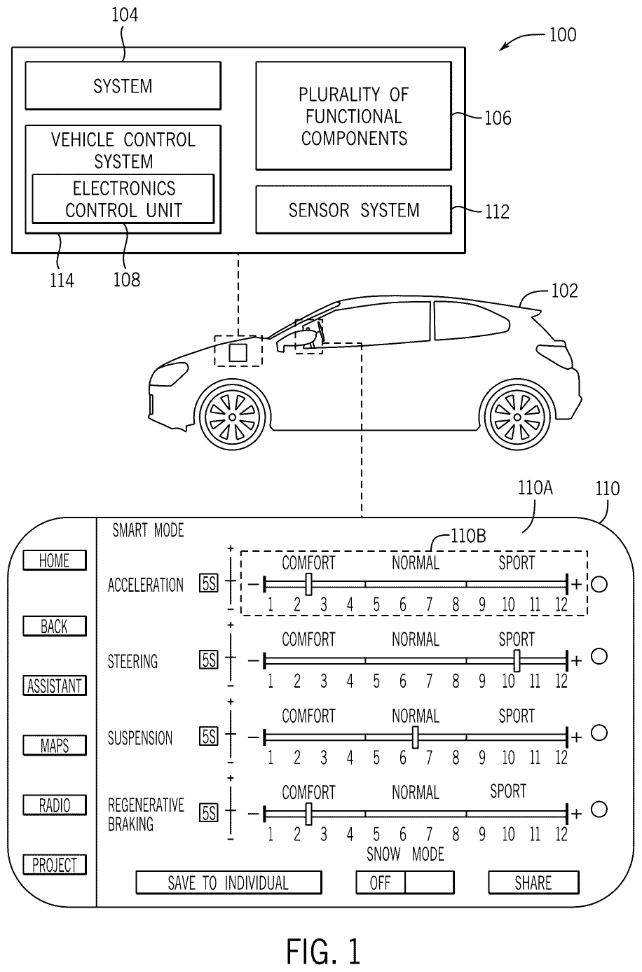

FIG. 1 is a diagram that illustrates an exemplary environment for updating values of mode parameters of a driving mode of a vehicle, in accordance with an embodiment of the disclosure. With reference to FIG. 1, there is shown a diagram that includes an environment 100. The environment 100 may include an operably connected vehicle 102 and system 104 that is communicatively coupled to a plurality of functional components 106 of the vehicle 102 and an electronic control unit (ECU) 108 of the vehicle 102. There is further shown a display device 110 that is integrated into the vehicle 102, though this is not required The display device 110 includes a Graphical User Interface (GUI) 110A that displays values of mode parameters 110B associated with an active drive mode. The environment 100 may further include a sensor system 112 and a vehicle control system 114.

The vehicle 102 may be a non-autonomous vehicle, a semi-autonomous vehicle, a fully autonomous vehicle, or a vehicular agent, for example, as defined by National Highway Traffic Safety Administration (NHTSA). Examples of the vehicle 102 may include, but are not limited to, a two-wheeled vehicle, a three-wheeled vehicle, a four-wheeled vehicle, a hybrid vehicle, or a vehicle with autonomous drive capability that uses one or more distinct renewable or non-renewable power sources. The vehicle may use renewable or non-renewable power sources, including a fossil fuel-based vehicle, an electric propulsion-based vehicle, a hydrogen fuel-based vehicle, a solar-powered vehicle, and/or a vehicle powered by other forms of alternative energy. Here, the vehicle 102 shown in FIG. 1 is a four-wheeled vehicle, which is merely an example. The present disclosure may be applicable to other types of vehicles (e.g., trucks, buses, bikes, and the like). The description of such types of the vehicle 102 has been omitted from the disclosure for the sake of brevity.

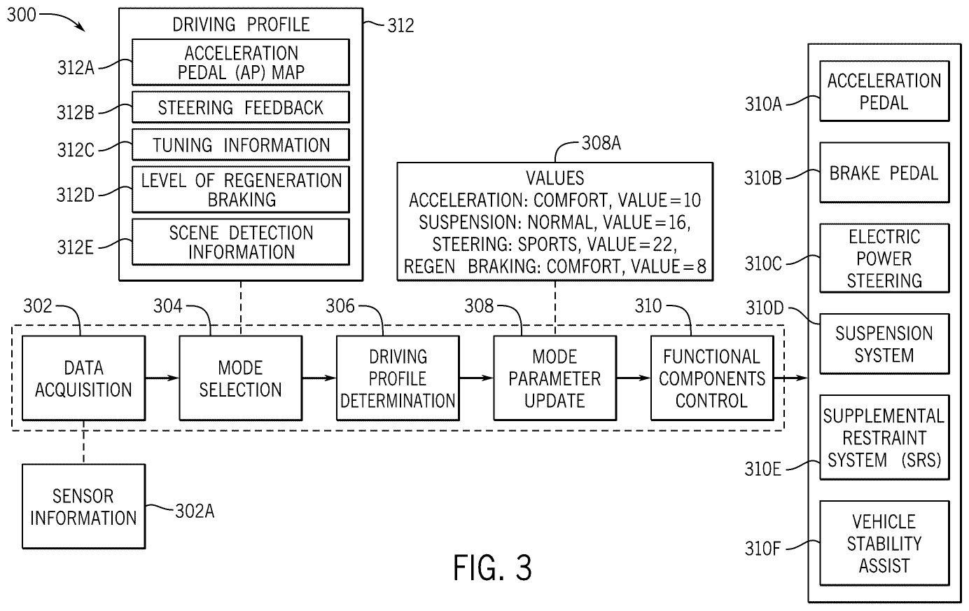

The plurality of functional components 106 may include, but is not limited to, an acceleration pedal, a brake pedal, an electric power steering, and a suspension system, for example. The functional components 106 may further include a supplemental restraint system (SRS) and a vehicle stability assist (VSA) system. The SRS (shown in FIG. 3) may be realized through several known safety technologies, such as a seat belt or an air bag. The VSA may comprise an Electronic Stability Control (ESC) system that may help to stabilize the vehicle 102 while the vehicle 102 is cornering and the movement of the vehicle 102 around a turn may become unsettled. The VSA may include a plurality of sensors (not shown) to monitor conditions associated with the road and a control mechanism to help reduce the possibility of skidding, plowing, or other loss-of-traction events. The VSA may improve the user's driving experience by enhancing control and stability of the vehicle 102 during acceleration, braking, or cornering of the vehicle 102. In some situations, the VSA may reduce throttle and brake individual wheels of the vehicle 102 to help restore the vehicle's 102 balance on the road.

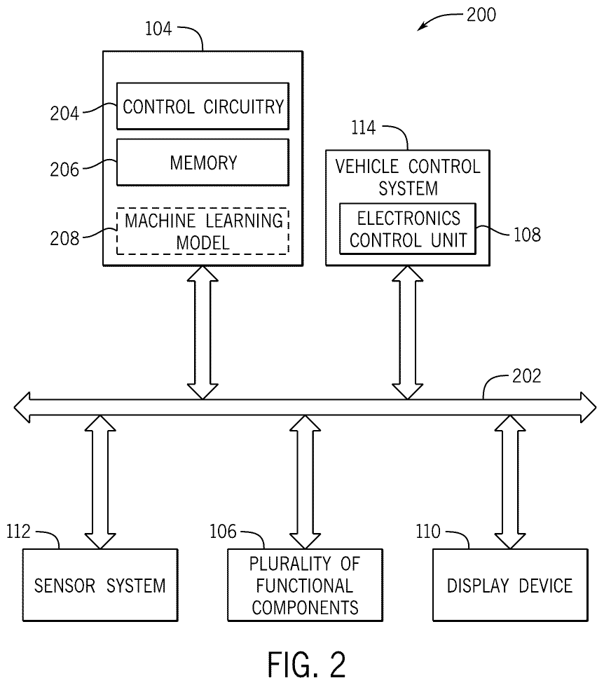

The plurality of functional components 106 may be controlled by the ECU 108, which may be linked with each of the functional components 106 and the vehicle control system 114 through an in-vehicle network (shown in FIG. 2). The ECU 108 may include suitable logic, circuitry, interfaces, and/or code that may be configured to control operation of the plurality of functional components 106. The ECU 108 may be a specialized electronic circuitry that may include an ECU processor to control different functions, such as, but not limited to, engine operations, tuning suspension system, regulating pressure of the master cylinder of brake, communication operations, and data acquisition associated with the sensor system 112 of the vehicle 102. In at least one embodiment, the ECU 108 may be further configured to control actuation of safety systems, such as, but not limited to, SRS and VSA.

The display device 110 may be communicatively coupled with the functional components 106 and the sensor system 112. The display device 110 may include suitable logic, circuitry, and interfaces that may be configured to display sensor information associated with the vehicle 102 and ambient information associated with an environment outside the vehicle 102. The display device 110 may be realized through several known technologies, such as but not limited to, a Liquid Crystal Display (LCD) display, a Light Emitting Diode (LED) display, a plasma display, or an Organic LED (OLED) display technology. In accordance with an embodiment, the display device 110 may refer to a display screen of a head mounted device (HMD), a smart-glass device, a see-through display, a projection-based display, an electro-chromic display, or a transparent display.

The sensor system 112 may include a plurality of sensors (not shown) in the vehicle 102 to acquire sensor information 302A. The sensor information 302A may include operational parameters associated with the vehicle 102 as well as the ambient information. For example, the operational parameters may include an acceleration pedal (AP) position associated with the acceleration pedal 310A of the vehicle 102, a master cylinder pressure associated with the brake pedal 310B of the vehicle 102, a steering angle associated with the electric power steering 310C of the vehicle 102, a plurality of suspension parameters associated with the suspension system 310D of the vehicle 102, and the like.

The sensor system 112 may further include a camera (not shown) which may be installed on at least one of: a front end or a rear end of the vehicle 102. The camera may include suitable logic, circuitry, or interfaces, that may be configured to capture images from multiple viewpoints to cover a 360-degree view of the surroundings of the vehicle 102. In accordance with an embodiment, the camera may further include a plurality of image sensors (not shown) to capture the 360-degree view of the surroundings of the vehicle 102. Examples of the camera may include, but are not limited to, an omnidirectional camera, a panoramic camera, an action camera, a wide-angle camera, a closed-circuit television (CCTV) camera, and/or other image capturing devices with image sensing capability. In an example embodiment, the camera may capture images of the environment 100 outside the vehicle 102 and such images may be used to detect a road condition, a type of road, a weather condition, a traffic condition, a terrain type, and the like on an active route. In accordance with an embodiment, the sensor system 112 may further include a rain sensor (not shown), which may be utilized to determine a level of precipitation in the environment outside the vehicle 102.

The sensor system 112 may further include a location sensor (not shown), which may include suitable logic, circuitry, and/or interfaces that may be configured to determine a current geo-location of the vehicle 102. Examples of the location sensor may include, but are not limited to, a Global Navigation Satellite System (GNSS)-based sensor, an Inertial Measurement Unit (IMU), or a combination thereof.

In accordance with an embodiment, the vehicle control system 114 may include the ECU 108. The vehicle control system 114 may include suitable logic, circuitry, interfaces, and/or code that may be configured to control operation of at least one of the functional components 106 via the ECU 108 of the vehicle 102. The vehicle control system 114 may be a specialized electronic circuitry that may control different functions, such as, but not limited to, engine operations, tuning suspension system, regulating pressure of the master cylinder of brake and actuation of the safety systems associated with the vehicle 102 (such as SRS and VSA).

In operation, the system 104 may be configured to receive the sensor information 302A associated with the vehicle 102. The sensor information 302A may be received from the sensor system 112 while the vehicle 102 is in a mobile state and a resting state. Additionally, or alternatively, raw sensor information from the sensor system 112 may be processed using suitable data processing algorithms to extract the sensor information 302A that is provided to the system 104. For example, images in the raw sensor information may be processed to extract scene information. The sensor information 302A may include operational parameters associated with the vehicle 102. Each of the operational parameters may correspond to a functional component of the plurality of functional components 106. By way of example, and not limitation, the operational parameters may include an AP position associated with the acceleration pedal of the vehicle 102, a master cylinder pressure associated with the brake pedal, a steering angle of the electric power steering, and a plurality of suspension parameters of the suspension system associated with the vehicle 102.

The system 104 may be further configured to receive the ambient information, which may include, for example, the road condition, the type of road, the terrain type, the level of precipitation, the current geo-location of the vehicle 102 associated with the environment outside the vehicle 102. In one or more embodiments, the system 104 may be configured to apply a machine learning model 208 (shown in FIG. 2) on the sensor information 302A to determine a driving profile 312 (shown in FIG. 3) associated with a user of the vehicle 102. The driving profile 312 may be determined prior to the system 104 selecting a driving mode associated with the vehicle 102. The driving profile 312 may also be determined in a selected driving mode associated with the vehicle 102 and the user of the vehicle 102.

The driving mode may include the mode parameters 110B (such as acceleration, steering, suspension, and a level of regenerative braking) associated with the plurality of functional components 106 of the vehicle 102. In an exemplary embodiment, the selected driving mode may be a dynamic mode or a SMART Mode that may allow the system 104 to update values of the individual mode parameters 110B based on the driving profile 312. In course of a journey, the update may be performed in real time or near real time as the driving profile 312 is updated based on new datapoints included in the sensor information 302A. In certain driving conditions (e.g., winding roads, snowy surfaces, straight highways, and similar scenarios), the driving mode may be prompted and selected as a preset mode (e.g., comfort, normal, or sport) specifically configured for the vehicle 102.

After the driving mode is selected, the system 104 may update values of the mode parameters 110B associated with the selected driving mode, based on the driving profile 312. Further, the system 104 may communicate the update with the one or more functional components 106, the display device 110, the sensor system 112, the ECU 108, and the vehicle control system 114 of the vehicle 102, via an in-vehicle network 202 (shown in FIG. 2). Based on the updated values of the mode parameters 110B, the system 104 may control, via the ECU 108, the plurality of functional components 106 of the vehicle 102.

FIG. 2 is a diagram that illustrates an exemplary vehicle system for updating values of mode parameters of a driving mode based on a learnable driving profile of the vehicle, in accordance with an embodiment of the disclosure. FIG. 2 is explained in conjunction with elements from FIG. 1. With reference to FIG. 2, there is shown a diagram 200 of a vehicle system that includes an in-vehicle network 202, control circuitry 204, and a memory 206. The in-vehicle network 202 may be communicatively coupled to the vehicle control system 114, which may further include the ECU 108. In accordance with an embodiment, the system 104 may store a machine learning model 208 in the memory 206. Alternatively, the system 104 may include a computer-executable program, which when executed, may communicate with a server that that may store the machine learning model 208 in a database, for example. The communication may be performed to utilize the machine learning model 208 for real time or near real time inference.

The in-vehicle network 202 may be communicatively coupled to the sensor system 112 and may enable transfer of the sensor information 302A to different electronic components that may be connected to the in-vehicle network 202. The in-vehicle network 202 may include a medium through which the various control units, components, and/or systems (for example, the plurality of functional components 106, the ECU 108, the display device 110, the sensor system 112, the vehicle control system 114) of the vehicle 102 may communicate with each other. In accordance with an embodiment, the in-vehicle network 202 may exist in the vehicle 102 to connect various devices or components in the vehicle 102, in accordance with various wired and wireless communication protocols. Examples of the wired and wireless communication protocols for the in-vehicle network 202 may include, but are not limited to, a vehicle area network (VAN), a CAN bus, Domestic Digital Bus (D2B), Time-Triggered Protocol (TTP), FlexRay, IEEE 1394, Carrier Sense Multiple Access With Collision Detection (CSMA/CD) based data communication protocol, Inter-Integrated Circuit (I²C), Inter Equipment Bus (IEBus), Society of Automotive Engineers (SAE) J1708, SAE J1939, International Organization for Standardization (ISO) 11992, ISO 11783, Media Oriented Systems Transport (MOST), MOST25, MOST50, MOST150, Plastic optical fiber (POF), Power-line communication (PLC), Serial Peripheral Interface (SPI) bus, and/or Local Interconnect Network (LIN).

The in-vehicle network 202 may be linked with the sensor system 112, which may acquire the sensor information 302A (shown in FIG. 3). The sensor information 302A may be shared with the control circuitry 204 of the system 104 for further processing. The sensor information 302A may include, for example, operational parameters associated with the vehicle 102 and the ambient information. Each of the operational parameters may correspond to a functional component of the plurality of functional components 106 of the vehicle 102. For example, a parameter such as AP position may correspond to an acceleration pedal of the vehicle 102. The ambient information may be associated with an environment outside of the vehicle 102.

The control circuitry 204 may include suitable logic, circuitry, and/or interfaces code that may be configured to execute program instructions associated with different operations to be executed by the system 104. The control circuitry 204 may include one or more specialized processing units. In an embodiment, such specialized processing units may be implemented as an integrated processor or a cluster of processors that perform the functions of the one or more specialized processing units, collectively. For example, the control circuitry 204 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or process data. Examples of the control circuitry 204 may include a Central Processing Unit (CPU), a Graphical Processing Unit (GPU), an x86-based processor, an x64-based processor, a Reduced Instruction Set Computing (RISC) processor, a Complex Instruction Set Computing (CISC) processor, and/or other hardware processors.

The memory 206 may include suitable logic, circuitry, interfaces, and/or code that may be configured to store the program instructions executable by the control circuitry 204. In at least one embodiment, the memory 206 may be configured to store the machine learning model 208, the sensor information 302A, and other information, such as a user profile and historical mode settings. The memory 206 may be a persistent storage medium, a non-persistent storage medium, or a combination thereof. Example implementations of the memory 206 may include, but are not limited to, Random Access Memory (RAM), Read Only Memory (ROM), Hard Disk Drive (HDD), a Solid-State Drive (SSD), a CPU cache, and/or a Secure Digital (SD) card.

The machine learning model 208 may be a classifier model or a regression that may be trained to identify a relationship between inputs, such as features in a training dataset. For example, the machine learning model 208 may predict values of mode parameters 110B associated with a selected driving mode of the vehicle 102 based on inputs (based on the sensor information 302A). The machine learning model 208 may be defined by its hyper-parameters, for example, weights, cost function, input size, number of layers, and the like. After several epochs of the training on the feature information in the training dataset, the machine learning model 208 may be trained to output a prediction/classification result for a set of inputs. The prediction result may be indicative of a class label (in case of classification) or a continuous mode parameter value (in case of a regression task) for each input of the set of inputs (e.g., input features extracted from new/unseen instances).

The machine learning model 208 may include electronic data, which may be implemented as, for example, a software component of an application executable on the system 104. The machine learning model 208 may rely on libraries, external scripts, or other logic/instructions for execution by a processing device, such as the control circuitry 204. The machine learning model 208 may utilize code and routines configured to enable a computing device to perform one or more operations. Additionally, or alternatively, the machine learning model 208 may be implemented using hardware including a processor, a microprocessor (e.g., to perform or control performance of one or more operations), a field-programmable gate array (FPGA), or an application-specific integrated circuit (ASIC). Alternatively, in some embodiments, the machine learning model 208 may be implemented using a combination of hardware and software. Examples of the machine learning model 208 may include, but are not limited to, a Multilayer Perceptron (MLP) regressor, a linear regression model, a logistic regression model, a random forest model, an artificial neural network, and a decision tree.

The functions or operations executed by the system 104, as described in FIG. 1, may be performed by the control circuitry 204. Operations executed by the control circuitry 204 are depicted in detail, for example, in FIGS. 3, 4A, 4B, 5, 6, 7A 7B, 8A, and 8B.

FIG. 3 is a diagram that illustrates an exemplary sequence of operations to update values of mode parameters of a driving mode of a vehicle, in accordance with an embodiment of the disclosure. FIG. 3 is explained in conjunction with elements from FIG. 1 and FIG. 2. With reference to FIG. 3, there is shown a block diagram 300 that includes a sequence of operations from 302 to 310.

At 302, data acquisition may be performed. The system 104 may receive sensor information 302A that includes the operational parameters associated with the vehicle 102 and the ambient information associated with an environment outside the vehicle 102. The data acquisition 302 may be performed via the sensor system 112 that may include a plurality of sensors (not shown) integrated into the plurality of functional components 106 of the vehicle 102 and/or other non-functional components (e.g., chassis) of the vehicle 102. Each of the operational parameters may correspond to at least one functional component of the plurality of functional components 106 of the vehicle 102. Examples of the operational parameters associated with the vehicle 102 may include, but is not limited to, an AP position of the vehicle 102, a master cylinder pressure associated with a brake pedal of the vehicle 102, a steering angle associated with an electric power steering of the vehicle 102, and a plurality of suspension parameters associated with a suspension system of the vehicle 102.

The ambient information may include, for example, a condition of a road in an active route of the vehicle 102, a terrain type associated with the active route, an amount of precipitation on the road, a type of the road, a weather condition for a current location of the vehicle 102 in the active route.

At 304, a mode selection may be performed. At any time-instant, the user or the system 104 may select a driving mode associated with the vehicle 102. For this exemplary embodiment, the selected driving mode may be referred to as a SMART Mode. The SMART Mode may allow the system 104 to dynamically update values of various mode parameters 110B associated with the selected driving mode based on a driving profile 312. Such parameters may be related to acceleration, steering, suspension, regenerative braking, safety, and the like.

For example, in the SMART Mode, the driving profile 312 may be determined. The system 104 may be configured to determine the driving profile 312 associated with the user of the vehicle 102, based on the sensor information 302A. Specifically, the driving profile 312 may include a mapping between input features (based on the operational parameters and the ambient information) and output variables such as the individual mode parameters 110B associated with a driving mode (e.g., the SMART Mode) of the vehicle 102. Such mode parameters 110B can be used to control the operation of the plurality of functional components 106 of the vehicle 102.

In accordance with an embodiment, the system 104 may learn the driving profile 312 by processing the sensor information 302A using a pre-trained machine learning model. Specifically, the system 104 may be configured to apply the pre-trained machine learning model (such as the machine learning model 208) on the sensor information 302A to determine the driving profile 312 associated with the user (e.g., the driver) of the vehicle 102.

In accordance with an embodiment, the system 104 may be further configured to acquire historical sensor data (not shown) associated with the vehicle 102, and the acquired data may be stored in the memory 206. The historical sensor data may include historical data points related to the operational parameters associated with the vehicle 102 and the ambient information associated with the environment around the vehicle 102. The system 104 may apply the machine learning model 208 on the historical sensor data to further determine the driving profile 312.

In determining the driving profile 312, the system 104 may be configured to set an adjustable time period over which the driving profile 312 is determined. The adjustable time period can be configured for either a short-term or long-term horizon. For example, the time period may range from 10 seconds to 1 minute, or even 10 minutes, depending on the desired level of responsiveness. These are merely examples, and the adjustable time period for determining the driving profile 312 is not particularly limited. The user of the vehicle 102 may also modify the adjustable time period via the GUI 110A via user input means, allowing for personalized control over how quickly or gradually the system 104 determines the driving profile 312.

The driving profile 312 may include, for example, an AP map 312A associated with an AP component of the vehicle 102, a steering feedback 312B associated with a steering component of the vehicle 102, tuning information 312C associated with a suspension component of the vehicle 102, a level of regenerative braking 312D associated with a braking component of the vehicle 102, and scene detection information 312E associated with the environment outside the vehicle 102.

The AP map 312A may indicate a desired output of a powertrain at a current speed value. The sensor system 112 may collect the acceleration pedal position data and a speed detection sensor (not shown) associated with the sensor system 112 may determine a speed of the vehicle 102. The AP map 312A may also indicate an amount of adjustment that may be required for an acceleration pedal 310A in accordance with the current speed of the vehicle 102. Typically, the user may depress the acceleration pedal 310A, which may indicate a desired adjustment of the acceleration pedal 310A required to maintain the speed of the vehicle 102 at the current value.

The steering feedback 312B may indicate a desired or an optimum steering angle that is to be maintained for a smooth steering of the vehicle 102. The sensor system 112 may collect a steering angle associated with the electric power steering 310C of the vehicle 102 and an angle sensor (not shown) associated with the sensor system 112 may determine a rotational effort or torque that the user applies to the steering wheel. The steering feedback 312B shows a value of adjustment for the steering angle in accordance with the rotational effort or torque applied by the user (as detected by the sensor system 112). The electric power steering 310C may include an electric motor which may be placed on a steering column of the electric power steering 310C. The electric motor may receive command from the ECU 108 regarding the value of adjustment in the steering angle to assist the user to steer the electric power steering 310C to a desired or optimum steering angle. Additionally, the steering feedback 312B may indicate a steering frequency, which can inform outputs of the system 104 and the associated vehicle 102 control.

The tuning information 312C may indicate a desired or an optimum adjustment of the damping force of the suspension system 310D. The sensor system 112 may measure a value of damping force experienced by the suspension system 310D of the vehicle 102. The tuning information 312C shows an amount of adjustment in the damping force, in accordance with current speed, acceleration, and braking of the vehicle 102 (as detected by the sensor system 112). The tuning information 312C may be used to adjust a speed of compression or rebound of a spring, such as, but not limited to, a spiral spring, a leaf spring, or a coil spring associated with the suspension system 310D.

In an exemplary embodiment, the suspension system 310D may include an air suspension, which may include alteration of stiffness of the spring by adjusting the effective volume of the spring associated with the suspension system 310D. The adjustment of the effective volume of the spring may be achieved via a solenoid valve to connect the spring to an extra volume (for example, an accumulator). Further, the extra volumes may allow the spring rate to be altered based on the ambient information, which may correspond to the road condition. In order to stiffen the spring while the vehicle 102 may be cruising at a higher speed, the solenoid may disconnect the extra volume. In case a softer spring rate is required based on the road condition, the solenoid may connect the extra volume.

The level of regenerative braking 312D may represent the intended or ideal amount of braking that the driver can implement using the brake pedal 310B or deceleration of the vehicle 102 that may be caused due to a level of adjustment of the acceleration pedal 310A. Depending on the user's driving profile, the level of regenerative braking 312D may be modified. The level of regenerative braking 312D may indicate a level of braking that needs to be adjusted depending on the vehicle's acceleration, current speed, and/or the state of the road. The level of regenerative braking 312D in one example embodiment may be at least one of low, moderate, and standard. The vehicle 102 may brake less and may be preferred for an open or empty road if the level of regenerative braking 312D is lower; conversely, if the level of regenerative braking 312D is higher and the road has heavy traffic, the vehicle 102 may brake more and may be preferred for that situation.

The scene detection information 312E may indicate environmental conditions, such as, but not limited to, objects in the active route of the vehicle 102, at least one pothole on the road, an impact generated on the vehicle 102, a road condition, a terrain type, or a weather condition. The system 104 may apply adjustments to at least one of the plurality of functional components 106 while the sensor system 112 collects the ambient information.

In accordance with an embodiment, a plurality of sensors in the sensor system 112 may be configured to monitor parameters or events that may contribute to skidding, plowing and other loss-of-traction events. The ECU 108 may activate the VSA 310F to improve the user's driving experience by enhancing control and stability of the vehicle 102 during acceleration, braking or cornering of the vehicle 102. The VSA 310F may reduce throttle and brake individual wheels of the vehicle 102 to help restore the movement of the vehicle 102 along an intended path.

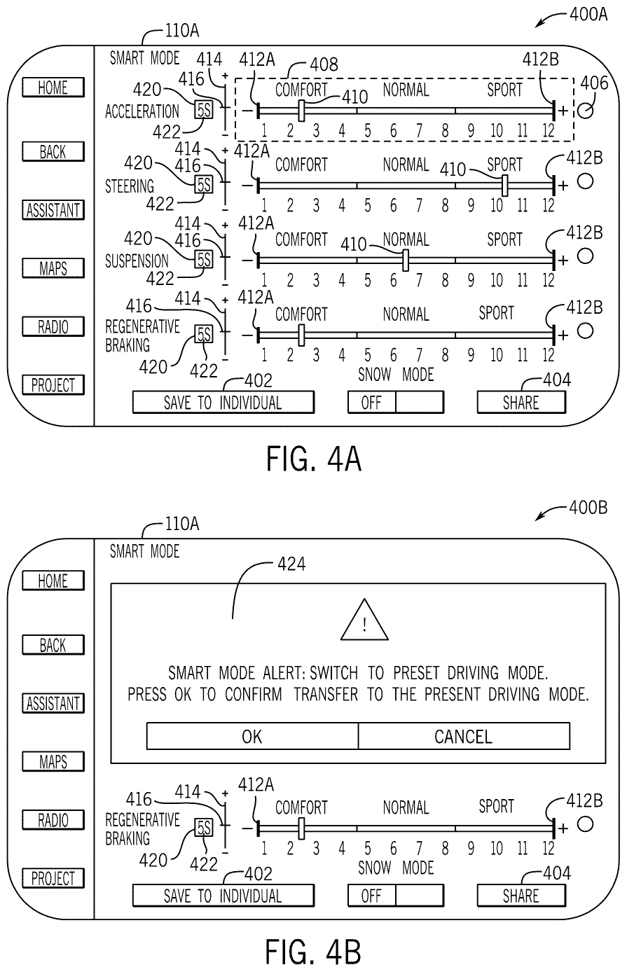

In this exemplary embodiment, based on the driving profile 312, at 308, values 308A of the mode parameters 110B may be updated. In the driving mode (i.e., the SMART Mode), the system 104 may update the values of the mode parameters 110B associated with the selected driving mode. The update may be performed based on the driving profile 312. As an example, the values of the mode parameters 110B may be updated so that a value of acceleration is 2, which may be a value associated with the comfort mode, a value of suspension is 6, which may be a value associated with the normal mode, a value of steering is 11, which may be a value associated with the sport mode, and a value of the level of regenerative braking is 4, which may be a value associated with the comfort mode. Other examples of the update are provided, for example, in FIGS. 4A, 4B, 5, 6, 7A,7B, 8A and 8B.

Furthermore, each mode parameter 110B may have a predetermined range of values. The mode parameter 110B associated with acceleration may have a range of values from 1 to 12, with each value corresponding to the control of the associated functional component under a specific driving mode (i.e., comfort mode, normal mode, or sport mode). Specifically, when the acceleration parameter is set between 1 and 4, the functional component controlling acceleration operates similarly to how it would in the comfort mode. When the value is set between 5 and 8, the functional component operates similarly to how it would in the normal mode. When the value is set between 9 and 12, the functional component operates similarly to how it would in the sport mode. Each mode parameter 110B may be individually adjusted and updated within the SMART Mode, with the values dynamically updated based on the driving profile 312.

Furthermore, the predetermined range of values may be adjusted by the user of the vehicle 102 through settable lower and upper thresholds. For example, the user may utilize the GUI 110A, which displays the mode parameters 110B, to set both the lower and upper thresholds. Using the acceleration mode parameter as an example, the user may set the lower threshold to 1 and the upper threshold to 8. This configuration constrains the mode parameter 110B associated with acceleration to remain within the operational ranges of the comfort mode (i.e., 1-4) and normal mode (i.e., 5-8), thereby preventing the component from operating in a manner associated with the sport mode, even if the driving profile 312 suggests a value typically associated with the sport mode. This adjustment can be made individually for each mode parameter 110B, allowing the user to fine-tune the operation of the vehicle's various functional components.

In an exemplary embodiment, the system 104 may initiate the updating of the values of the mode parameters 110B based on user-defined sensitivity settings. These sensitivity settings may establish trigger thresholds that dictate when adjustments to the mode parameters 110B should occur, based on the sensor information 302A received. For example, the sensitivity settings could define how quickly the system 104 reacts to changes in environmental conditions, vehicle speed, or driver behavior. A lower sensitivity setting might result in more gradual adjustments, while a higher sensitivity setting could prompt the system 104 to make quicker, more immediate adjustments to the mode parameters 110B in response to even minor changes in the sensor information 302A acquired by the sensor system 112 and affecting the driving profile 312.

The sensitivity settings may be associated with the driving profile 312 and are fully user configurable. This allows users to fine-tune the vehicle's 102 responsiveness, determining how aggressively the system 104 adjusts the mode parameters 110B. For example, the user could modify the sensitivity settings through the GUI 110A using input means. However, user input for configuring the sensitivity settings and the range of values for the mode parameters 110B is not limited to the GUI 110A. It may also be carried out via a mobile device application associated with the vehicle 102 or other known methods of vehicle system connectivity.

These configurable sensitivity settings may give the user an additional layer of control over how the vehicle 102 behaves, enhancing the personalized driving experience provided by the SMART Mode. By adjusting both the mode parameter ranges and the trigger sensitivity thresholds, the system 104 ensures that the vehicle's 102 performance is optimized in real-time to meet the user's specific preferences, while still being adaptive to changing environmental and operational conditions.

Furthermore, in accordance with an embodiment, the sensor system 112 may include sensors which may be configured to detect a cruise operation of the vehicle 102. The system 104 may be configured to detect an execution of the cruise control operation for a duration of a movement of the vehicle 102. Based on the detection, the update of the values of the mode parameters may be paused for the duration.

At 310, functional components 106 of the vehicle 102 may be controlled. The system 104 may be configured to control, via the ECU 108 of the vehicle 102, the plurality of functional components 106 of the vehicle 102 based on the updated values of the mode parameters 110B. Even if the user is unable to define the desired driving experience, the vehicle 102 can quickly adapt to provide the desired driving experience by dynamically adjusting the values of the mode parameters 110B (in close to real-time) and controlling the plurality of functional components 106 (in close to real-time).

In an embodiment, the system 104 may be configured to proactively adjust some or all of the mode parameters 110B in the SMART Mode based on the sensor information 302A acquired by the sensor system 112. For example, if the sensor system 112 detects a winding road, the user may be prompted to switch all the mode parameters 110B to values associated with the sport mode. Conversely, if the sensor information indicates a steady drive, the user may be prompted to switch some or all of the mode parameters 110B to values associated with the comfort mode. The user may accept or decline these suggested changes via the GUI 110A. These adjustments are not limited to the given examples; the system 104 may prompt mode parameter changes in the SMART Mode based on various factors detected by the sensor system 112, including proactive changes in response to environmental conditions and reactive changes based on user inputs. Furthermore, while in SMART Mode, the system 104 may be configured to alternatively prompt the user to switch to one of the preset modes (e.g., comfort mode, normal mode, or sport mode) based on the sensor information 302A, which the user can accept or decline.

In accordance with an embodiment, the display device 110 may include the GUI 110A that may be configured to render required information to the user (i.e., a driver/occupant of the vehicle). For example, the GUI 110A may render information regarding the selected driving mode and the updated values of the mode parameters 110B.

FIGS. 4A and 4B are diagrams that collectively illustrate a graphic user interface (GUI) of a display device associated with a vehicle, in accordance with an embodiment of the disclosure. FIGS. 4A and 4B are explained in conjunction with elements from FIG. 1, FIG. 2, and FIG. 3. With reference to FIGS. 4A and 4B, there are shown diagrams 400A and 400B of the GUI 110A, which may be rendered on the display device 110 of the vehicle 102. The GUI 110A may display graphical elements that may correspond to user-selectable options for a view selection, a display control, and other interactive user-options. Additionally, the GUI 110A may render the selected driving mode, the mode parameters 110B associated with the selected driving mode, the updated values of the mode parameters 110B, and user input elements.

The GUI 110A may include a first UI element 402, which may save updated values of the mode parameters 110B in the SMART Mode. In case a user feels comfortable with the updated values of the mode parameters 110B, the user may save the updated values by clicking on the first UI element 402. The GUI 110A may further include a second UI element 404, which may share the SMART Mode user settings (e.g. mode parameter values, driving profile) with a vehicle that may be associated with a person who is different from the user. For example, the user may share, via a platform, the SMART driving mode with a friend's vehicle that supports custom driving modes. The platform may include but is not limited to one of a mail, a social media platform, a cloud server, a Vehicle-to-Vehicle (V2V) network, or a WAN network.

The GUI 110A may include a first option 406, which when selected, may lock at least one of the updated values of the mode parameters 110B. For example, the system 104 may receive a selection of the first option 406 and may ignore the update of at least one of the values of the mode parameters 110B based on the selection of the first option 406. In some instances, the first option 406 may be selected if the user is dissatisfied with the updated values of the mode parameters 110B and desires to lock some or all of the values of the mode parameters 110B. In some embodiments, the first option 406 may be automatically selected to lock the update of the values of the mode parameters 110B if the vehicle 102 is determined to be in a cruise mode or a snow mode.

The GUI 110A may include a slider UI element 408 for each of the mode parameters. Each segment of the slider UI element 408 may represent a range of values corresponding to a driving mode for the associated mode parameter 110B, where the predetermined range of values (e.g., 1-12) is shown for each mode parameter 110B. In an exemplary embodiment, each segment may correspond to one of the comfort mode, normal mode, or sport mode. The slider UI element 408 visually indicates the range of values for the mode parameters 110B. For example, the comfort mode may have the lowest range, the sport mode the highest, and the normal mode falls between the two.

In accordance with an embodiment, the GUI 110A may further include an indicator 410, which may indicate the updated values of the mode parameters 110B. The indicator 410 may move along the length of the slider UI element 408 as individual values of the mode parameters 110B are updated. Specifically, the update of each value of the mode parameters 110B may be followed by a movement of the indicator 410 along the slider UI element 408.

In the SMART Mode, the GUI 110A may also include a range adjustor 412, allowing the user to configure the range of values for each mode parameter 110B, including the settable lower threshold 412A and the upper threshold 412B. Additionally, the GUI 110A may feature a slider sensitivity UI element 414 associated with the sensitivity setting for each mode parameter 110B, a sensitivity indicator 416 showing the current sensitivity setting associated with the corresponding mode parameter 110B, and the sensitivity indicator 416 allows the user to adjust the sensitivity settings for each mode parameter 110B. The sensitivity setting may be displayed as a value (e.g., 1-10), though this should not be considered limiting as it is merely an example.

Furthermore, in the SMART Mode, the GUI 110A may include a driving profile time horizon 420 element, which displays a user-adjustable time horizon for determining the driving profile 312. The GUI 110A may also include a time horizon input element and indicator 422, allowing the user to configure the time range over which the driving profile 312 is determined (e.g., seconds, minutes, etc.), and showing the current time horizon setting. This configuration is not limited to a single time input for all mode parameters 110B and may be separately applied to each mode parameter 110B, ensuring that the determination of the driving profile 312 is elaborate and thorough, leading to an optimized SMART Mode.

In accordance with an embodiment, the GUI 110A may include a prompt overlay 424, which may provide an option to switch to a preset driving mode that may be for a weather condition or a road traffic condition. In an embodiment, the system 104 may store the preset driving mode in the memory 206 and conditions to trigger the prompt overlay 424. At any time instant, the system 104 may receive the ambient information that may specify weather and road traffic conditions. If such conditions match the conditions stored in the memory 206 for the preset driving mode, the GUI 110A may display the prompt overlay 424. The system 104 may receive a selection of the option in the prompt overlay 424 and may select the preset driving mode based on the selection.

After the selection of the preset driving mode, the system 104 may control the plurality of functional components 106 based on values of the mode parameters 110B associated with the preset driving mode. For example, the preset driving mode may be a snow mode for snowy conditions. A message may be rendered on the GUI 110A to indicate that the vehicle 102 is currently in the selected preset driving mode. While the preset mode (e.g., snow mode) is active, the updated values of the mode parameters 110B for the SMART Mode may not be used. If the vehicle 102 exits the preset driving mode, then the system 104 may switch to the updated values of the mode parameters 110B for the SMART Mode.

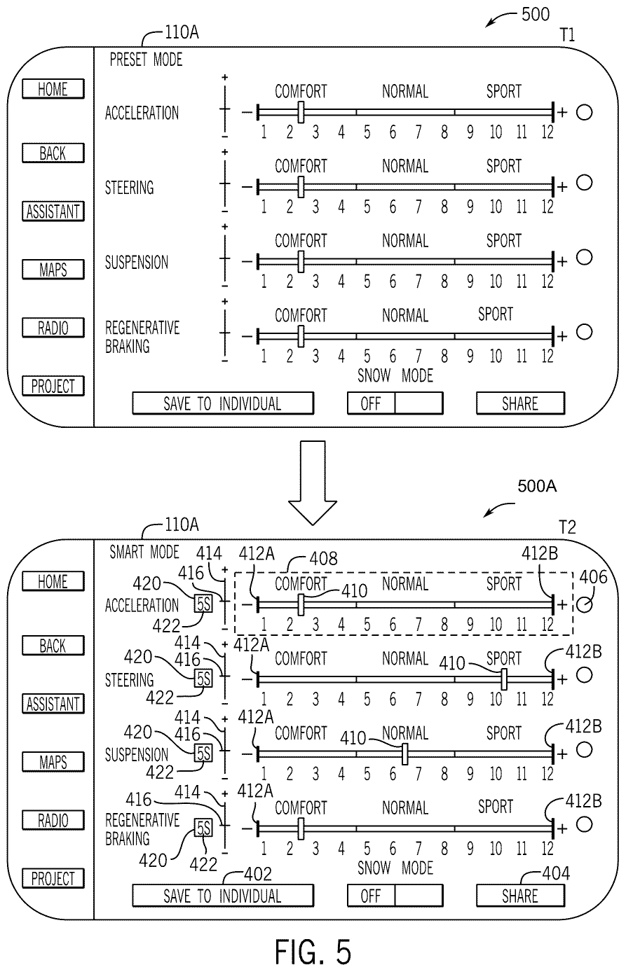

FIG. 5 is an exemplary scenario diagram that illustrates a change from a preset driving mode to the SMART Mode, in accordance with an embodiment of the disclosure. FIG. 5 is explained in conjunction with elements from FIG. 1, FIG. 2, FIG. 3, and FIGS. 4A and 4B. With reference to FIG. 5, there are shown scenario diagrams 500 and 500A that include the GUI 110A at a time instant T1 and the GUI 110A at time instant T2.

At time T1, an initial driving mode may be selected as a default or preset mode, with the mode parameter values adjusted to fall within the comfort mode range for example. At this time, the system 104 may receive sensor information 302A. Based on this information, the system 104 may prompt the user to switch to the SMART Mode, or the user may voluntarily switch to the SMART Mode prior to receiving the prompt. In the SMART Mode, at time T2, the driving profile 312 is determined. Alternatively, the driving profile 312 may be determined while in the preset mode. If applicable, the system 104 may then prompt the user to switch to SMART Mode, where the driving profile 312 determined in the preset mode can serve as an initial basis for further determining the driving profile 312 in the SMART Mode.

Based on the determined driving profile 312, the system 104 may update the values of the individual mode parameters 110B. The update may be performed regularly or continuously in increments associated with the adjustable time period for determining the driving profile 312 in near real time while the vehicle 102 stays in the SMART Mode. The updated values of the mode parameters 110B are depicted by new positions of the indicators. As an example, the value for steering may change from a value associated with the comfort mode to a value associated with the sport mode, while the value for suspension may change from a value associated with the comfort mode to a value associated with the normal mode.

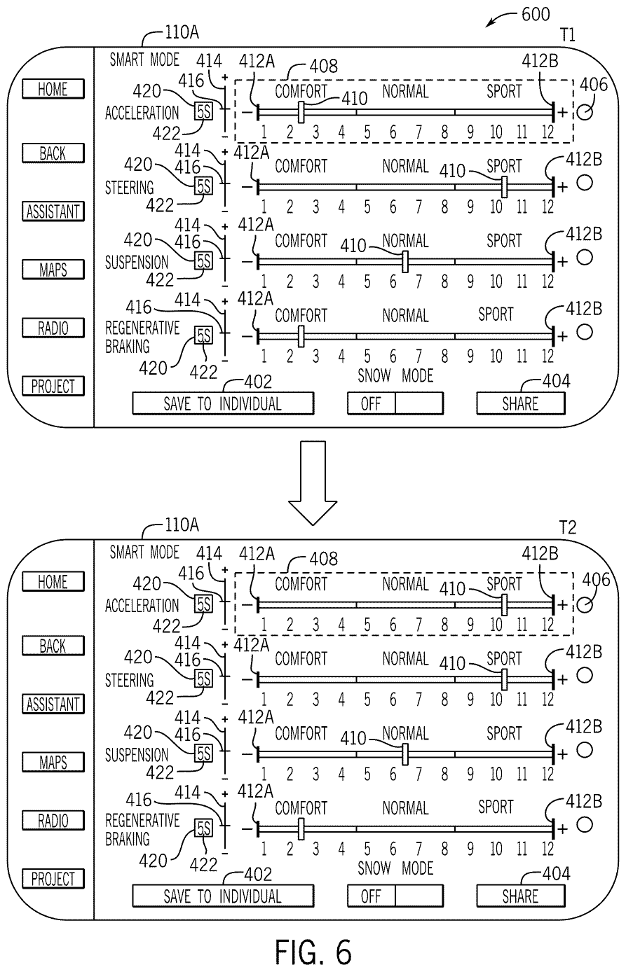

FIG. 6 is an exemplary scenario diagram that illustrates an update in mode parameters in a SMART driving mode at different time instant, in accordance with an embodiment of the disclosure. FIG. 6 is explained in conjunction with elements from FIG. 1, FIG. 2, FIG. 3, FIGS. 4A and 4B, and FIG. 5. With reference to FIG. 6, there is shown a scenario diagram 600 that includes the GUI 110A at a time instant T1 and the GUI 110A at time instant T2. At T1, the vehicle 102 may be in the SMART Mode and the values of the mode parameters 110B corresponding to the SMART Mode are shown.

At T2, the system 104 may receive the sensor information 302A and may update the driving profile 312 based on the received sensor information 302A. Based on the updated driving profile 312, the system 104 may further update the values of the mode parameters 110B, as shown (at T2). The updated values of the mode parameters 110B are depicted by new positions of the indicators 410. In an exemplary embodiment, the value for the acceleration may update from a value associated with the comfort mode to a value associated with the sport mode, the value for steering may update from a value associated with the sport mode to a value associated with the normal mode, the value for suspension may update from a value associated with the normal mode to a value associated with the sport mode, and the value of regenerative braking may update to a new value still associated with the comfort mode (e.g., the value at T1 may be 2 and at time T2 may be 3).

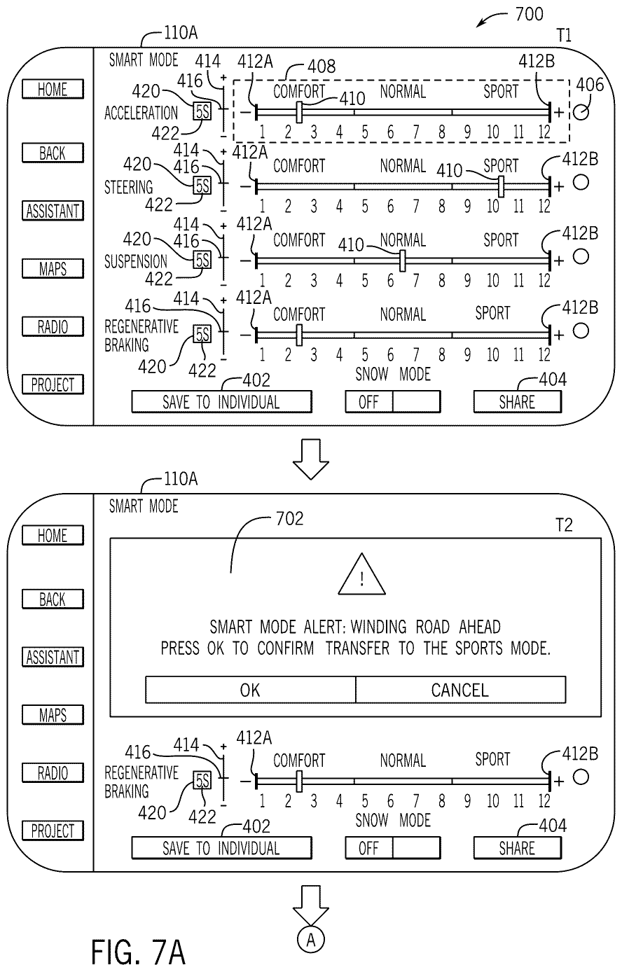

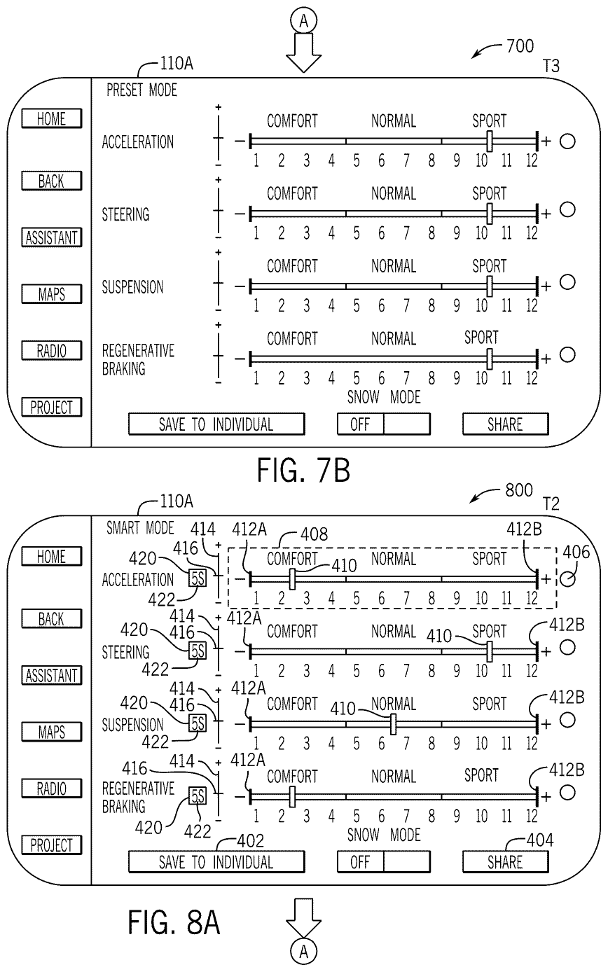

FIGS. 7A and 7B are diagrams that collectively illustrate an exemplary scenario for updating values of mode parameters based on a winding road condition, in accordance with an embodiment of the disclosure. FIGS. 7A and 7B are explained in conjunction with elements from FIG. 1, FIG. 2, FIG. 3, FIGS. 4A and 4B, FIG. 5, and FIG. 6. With reference to FIGS. 7A and 7B, there is shown an exemplary scenario 700 that includes the GUI 110A at a time instant T1, a GUI 110A with a prompt overlay 702 for a winding road condition at a time instant T2, and the GUI 110A at time instant T3.

At T1, values of the mode parameters 110B may be adjusted as per the SMART Mode. As shown, for example, the GUI 110A includes the slider for each mode parameter 110B (i.e., acceleration, steering, suspension, and braking) which is within the range of values. In the SMART Mode, the system 104 may update individual mode parameters 110B based on the driving profile 312. In some instances, the user may be allowed to make changes in the values of the individual mode parameters via one or more options in the GUI 110A.

At T2, the system 104 may detect a winding road condition based on the ambient information (e.g., road images). Based on the detection, the system 104 may display, on the GUI 110A, the prompt overlay 702 which provides an option to switch to a preset driving mode, such as the sport mode.

At T3, the system 104 may receive, via the GUI 110A, a selection of the option in the prompt overlay 702. Based on the selection, the preset driving mode (such as the sport mode) may be selected. The system 104 may further control the plurality of functional components 106 based on values of the mode parameters 110B associated with the preset driving mode. When a particular pre-set mode such as the sport mode is active, the system 104 may not update individual mode parameters of the particular mode based on the driving profile 312. The updated values of the mode parameters 110B are depicted by new positions of the indicators 410 in the GUI 110A.

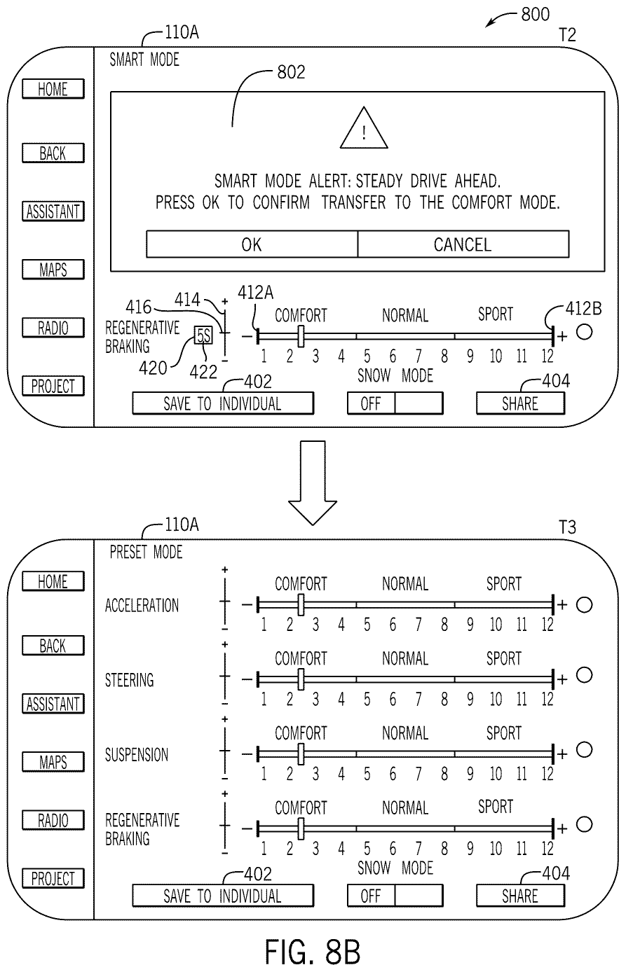

FIGS. 8A and 8B are diagrams that collectively illustrate an exemplary scenario for updating values of mode parameters based on a steady drive condition, in accordance with an embodiment of the disclosure. FIGS. 8A and 8B are explained in conjunction with elements from FIG. 1, FIG. 2, FIG. 3, FIGS. 4A and 4B, FIG. 5, FIG. 6, and FIGS. 7A and 7B. With reference to FIGS. 8A and 8B, there is shown an exemplary scenario 800 that includes the GUI 110A at a time instant T1, a GUI 110A with a prompt overlay 802 for a steady drive condition at a time instant T2, and the GUI 110A at a time instant T3.

At T1, values of mode parameters 110B may be adjusted as per the smart mode. As shown, for example, the GUI 110A includes the slider for each mode parameter 110B (i.e., acceleration, steering, suspension, and braking) which is within a specific range of values. In the SMART Mode, the system 104 may update individual mode parameters 110B based on the driving profile 312. In some instances, the user may be allowed to make changes in the values of the individual mode parameters 110B via one or more options in the GUI 110A.

At T2, the system 104 may detect a steady drive condition (e.g., a long highway) based on the ambient information (e.g., road images). Based on the detection, the system 104 may display, on the GUI 110A, the prompt overlay 802 which provides an option to switch to a preset driving mode, such as the comfort mode.

At T3, the system 104 may receive, via the GUI 110A, a selection of the option in the prompt overlay 802. Based on the selection, the preset driving mode (such as the comfort mode) may be selected. The system 104 may further control the plurality of functional components 106 based on values of the mode parameters 110B associated with the preset driving mode. When a particular pre-set mode such as the comfort mode is active, the system 104 may not update individual mode parameters 110B of the particular mode based on the driving profile 312. The updated values of the mode parameters 110B are depicted by new positions of the indicators in the GUI 110A.

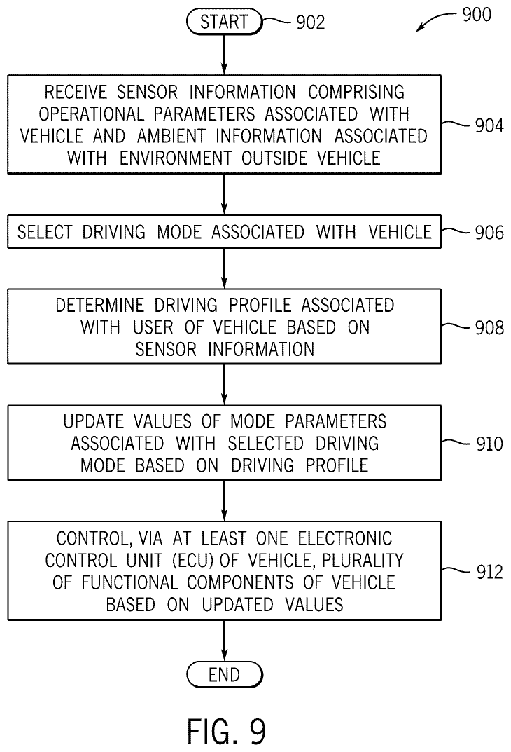

FIG. 9 is a flowchart that illustrates an exemplary method of updating values of mode parameters of a driving mode of a vehicle, in accordance with an embodiment of the disclosure. FIG. 9 is explained in conjunction with elements from FIG. 1, FIG. 2, FIG. 3, FIGS. 4A and 4B, FIG. 5, FIG. 6, FIGS. 7A and 7B, and FIGS. 8A and 8B. With reference to FIG. 9, there is shown a flowchart 900, which may depict exemplary operations that are performed by an exemplary system, such as the system 104 of FIG. 1 or any suitable system, apparatus, or device, such as the control circuitry 204. The method illustrated in the flowchart 900 may start at 902 and proceed to 904.

At 904, sensor information 302A may be received. In one or more embodiments, the control circuitry 204 may receive the sensor information 302A which may include operational parameters associated with the vehicle 102 and the ambient information associated with an environment outside the vehicle 102, as further described, for example, in FIG. 1, FIG. 2, and FIG. 3.

At 906, the driving mode associated with the vehicle 102 may be selected via prompt, or prior to prompting, by the user. In one or more embodiments, the control circuitry 204 may select the driving mode associated with the vehicle 102, as described, for example, in FIG. 1, FIG. 2, FIG. 3, and FIGS. 4A and 4B.

At 908, the driving profile 312 associated with a user of the vehicle 102 may be determined in the selected driving mode based on the sensor information 302A. In one or more embodiments, the control circuitry 204 may determine the driving profile 312 associated with the user of the vehicle 102, as further described, for example, in FIG. 1, FIG. 2, and FIG. 3.

In 910, values of mode parameters 110B associated with the selected driving mode based on the driving profile 312 are updated. In one or more embodiments, the control circuitry 204 may update values of the mode parameters 110B associated with the selected driving mode, as described, for example, in FIG. 1, FIG. 2, FIG. 3, and FIGS. 4A and 4B.

At 912, the plurality of functional components 106 of the vehicle 102 may be control via the at least one ECU 108 of the vehicle 102. In one or more embodiments, the control circuitry 204 may control via the at least one ECU 108 of the vehicle 102, the plurality of functional components 106 of the vehicle 102 based on the updated values of the mode parameters 110B, as described, for example, in FIG. 1, FIG. 2, FIG. 3, and FIGS. 4A and 4B. Control may pass to end.

At any step of 908, 910, or 912, the user of the vehicle 102 may interact with the system 104 through the GUI 110A, or a communicatively connected mobile device, to modify various settings related to the mode parameters 110B. Specifically, the user can adjust the range of values for each mode parameter 110B (e.g., acceleration, steering, suspension, regenerative braking) by setting lower and upper thresholds 412A, 412B, ensuring that the functional components 106 of the vehicle 102 operate within the desired performance boundaries. Additionally, the user can modify the time horizon 420 over which the driving profile 312 is determined. The user can also change the sensitivity settings 416 associated with each mode parameter 110B, controlling how responsive the system 104 is to changes in the sensor information 302A. By increasing or decreasing sensitivity using the slider sensitivity UI element 414, the user can determine how quickly the system 104 reacts to variations in driving conditions or behavior, ensuring a tailored driving experience that aligns with their preferences. These adjustments can be made in real-time or near real-time, allowing the system 104 to immediately incorporate the changes into its control of the vehicle's 102 functional components 106 via the ECU 108.

Although the flowchart 900 is illustrated as discrete operations, such as 902, 904, 906, 908, 910, and 912, the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory, computer-readable medium and/or storage medium, and/or a non-transitory machine readable medium and/or storage medium stored thereon, a set of computer-executable instructions executable by the system 104 associated with the vehicle 102. The set of instructions may be executable by the system 104 to perform operations that may include receiving the sensor information 302A which may include operational parameters associated with the vehicle 102 and the ambient information associated with an environment outside the vehicle 102. The operations may further include selecting a driving mode associated with the vehicle 102 and determining the driving profile 312 associated with a user of the vehicle 102 based on the sensor information 302A. The operations may further include updating values of mode parameters 110B associated with the selected driving mode based on the driving profile 312. The operations may further include controlling, via at least one ECU 108 of the vehicle 102, the plurality of functional components 106 of the vehicle 102 based on the updated values of the mode parameters 110B.

The present disclosure may be implemented in hardware, software, or a combination of both. It may be realized in a centralized system, such as a single computer, or in a distributed fashion, where different components are spread across interconnected computer systems. A system or apparatus adapted to perform the methods described herein may be suitable. A combination of hardware and software may include a general-purpose computer system with a program that, when executed, controls the system to carry out the described methods. Additionally, the present disclosure may be implemented in hardware that is part of an integrated circuit performing other functions. Depending on the embodiment, some steps may be omitted, others added, and the sequence of steps may be adjusted.

The present disclosure may also be embedded in a computer program product that includes all the necessary features to implement the described methods. When loaded into a computer system, it can carry out these methods. A “computer program” refers to any set of instructions, in any language, code, or notation, designed to cause a system with information processing capabilities to perform a specific function, either directly or after conversion to another form. While specific embodiments have been described, it will be understood that various modifications may be made without departing from the scope of the disclosure. The present disclosure is intended to cover all embodiments within the scope of the appended claims.

Terms such as “component,” “module,” “system,” and “interface” generally refer to a computer-related entity, which can be hardware, software, or a combination of both. For instance, a component could be a process running on a processor, an object, an executable, or a computer system. Components may reside on a single computer or be distributed across multiple systems.

The claimed subject matter may be implemented as a method, apparatus, or article of manufacture using standard programming or engineering techniques. The term “article of manufacture” encompasses any computer program accessible from any computer-readable device or media. Various modifications may be made without departing from the scope or spirit of the claimed subject matter.

Aspects described herein involve “computer-readable instructions” executed by one or more computing devices. These instructions may be distributed via computer-readable media and implemented as program modules, such as functions, objects, APIs, or data structures. The functionality of these instructions can be combined or distributed in various environments, and, for example, stored in the memory 206 of the system 104 for execution by a processor.

The term “computer-readable media” includes both storage media and communication media. Storage media may include volatile and non-volatile, removable, and non-removable forms, such as RAM, ROM, flash memory, CD-ROMs, DVDs, or magnetic storage devices. Examples include memory 206 or a storage drive of the system 104. Communication media involve data signals, such as carrier waves or other transport mechanisms, that embody computer-readable instructions. Communication media typically embody computer-readable instructions or other data in a “modulated data signal,” such as a carrier wave, which encodes information.

Although the subject matter has been described with reference to specific features and methodologies, it is understood that various changes can be made without departing from the scope of the appended claims. Operations described herein should not be construed as requiring a specific order. Alternative sequences may be appreciated based on this description. Further, not all operations may be present in each aspect described.

The term “or” is intended to be inclusive unless specified otherwise, meaning A, B, or any combination thereof. Similarly, “a” and “an” typically mean “one or more” unless context indicates otherwise. Terms like “includes” and “having” are meant to be inclusive, similar to “comprising.” Terms such as “first” and “second” are used as identifiers and do not imply any specific order or hierarchy. For instance, a “first channel” and a “second channel” may simply refer to two different or identical channels, not necessarily in a specific order.

It will be appreciated that various features and functions discussed herein may be combined in different ways. For example, the behavior prediction technology described could be extended to facilitate vehicle exits, using internal cameras to predict and respond to a user's intent to exit the vehicle. Additionally, unforeseen alternatives, modifications, or improvements may arise, and these too are intended to be encompassed by the following claims.

1. A system, comprising:
control circuitry configured to:
receive sensor information including operational parameters associated with a vehicle and ambient information associated with an environment outside the vehicle;
select a driving mode from a plurality of driving modes associated with the vehicle;
determine a driving profile in the selected driving mode associated with a user of the vehicle based on the sensor information;
update values of mode parameters associated with the selected driving mode based on the driving profile; and
control, via at least one electronic control unit (ECU) of the vehicle, a plurality of functional components of the vehicle based on the updated values, wherein
each of the mode parameters has a predetermined range of values, the range of values being adjustable via a settable lower threshold and a settable upper threshold, and the updated values for each of the mode parameters are constrained to remain within bounds of the lower threshold and the upper threshold.

2. The system according to claim 1, wherein each of the mode parameters corresponds to at least one functional component of the plurality of functional components.

3. The system according to claim 2, wherein the plurality of functional components includes at least one of an acceleration pedal, a brake pedal, an electric power steering, a suspension system, a supplemental restraint system (SRS), or a vehicle stability assist (VSA).

4. The system according to claim 2, wherein the control circuitry is further configured to set an adjustable time period over which the driving profile is determined.

5. The system according to claim 1, wherein the operational parameters associated with the vehicle includes at least one of an acceleration pedal (AP) position of the vehicle, a master cylinder pressure associated with a brake pedal of the vehicle, a steering angle associated with an electric power steering of the vehicle, and a plurality of suspension parameters associated with a suspension system of the vehicle.

6. The system according to claim 1, wherein the ambient information associated with the environment includes at least one of a condition of a road in an active route of the vehicle, a terrain type associated with the active route, an amount of precipitation on the road, a type of the road, a weather condition for a current location of the vehicle in the active route.

7. The system according to claim 1, wherein the driving profile includes at least one of:
an acceleration pedal (AP) map associated with an AP component the vehicle;
a steering feedback associated with a steering component of the vehicle;
tuning information associated with a suspension component of the vehicle;
a level of regenerative braking associated with a braking component of the vehicle; and
scene detection information associated with the environment outside the vehicle.

8. The system according to claim 1, wherein the control circuitry is further configured to apply a pre-trained machine learning (ML) model on the sensor information to determine the driving profile associated with the user.

9. The system according to claim 1, wherein the control circuitry is further configured to acquire historical sensor data associated with the vehicle, and wherein the driving profile is determined further based on the historical sensor data.

10. The system according to claim 1, wherein the control circuitry is further configured to control a display device associated with the vehicle to render the selected driving mode, the mode parameters, and the updated values of mode parameters on a Graphical User Interface (GUI).

11. The system according to claim 10, wherein the GUI includes:
a first UI element to save the updated values of mode parameters in the selected driving mode which is a smart driving mode, and
a second UI element to share the smart driving mode with at least another vehicle.

12. The system according to claim 10, wherein updating values of the mode parameters is initiated based on at least sensitivity settings that define trigger thresholds for adjustments to the mode parameters triggered by the sensor information, the sensitivity settings being associated with the driving profile, and wherein the sensitivity settings are user configurable.

13. The system according to claim 10, wherein the GUI further comprises a first option to lock at least one value of the updated values of mode parameters, and wherein the control circuitry is further configured to:
receive a selection of the first option; and
ignore the update of at least one of the values of mode parameters based on the selection of the first option.

14. The system according to claim 10, wherein the GUI further includes a slider UI element for each of the mode parameters, where a length of the slider UI element represents the range of values, and each segment of the length of the slider UI element represents a mode range of values associated with a type of mode for a corresponding mode parameter of the selected driving mode, and
the lower threshold and the upper threshold are set using the slider.

15. The system according to claim 14, wherein the update of the values is represented by a movement of an indicator along the length of the slider UI element.

16. A method, comprising:
in a system associated with a vehicle:
receiving sensor information including operational parameters associated with a vehicle and ambient information associated with an environment outside the vehicle;
selecting a driving mode from a plurality of driving modes associated with the vehicle;
determining a driving profile in the selected driving mode associated with a user of the vehicle based on the sensor information;
updating values of mode parameters associated with the selected driving mode based on the driving profile; and
controlling, via at least one electronic control unit (ECU) of the vehicle, a plurality of functional components of the vehicle based on the updated values, wherein
each of the mode parameters has a predetermined range of values, the range of values being adjustable via a settable lower threshold and a settable upper threshold, and the updated values for each of the mode parameters are constrained to remain within bounds of the lower threshold and the upper threshold.

17. The method according to claim 16, wherein each of the mode parameters corresponds to at least one functional component of the plurality of functional components.

18. The method according to claim 17, wherein the plurality of functional components includes at least one of an acceleration pedal, a brake pedal, an electric power steering, a suspension system, a supplemental restraint system (SRS), or a vehicle stability assist (VSA).

19. The method according to claim 16, wherein an adjustable time period over which the driving profile is determined is adjustable.

20. A non-transitory computer-readable medium having stored thereon, computer-executable instructions which, when executed by a system associated with a vehicle, cause the system to execute operations, the operations comprising:
receiving sensor information including operational parameters associated with a vehicle and ambient information associated with an environment outside the vehicle;
selecting a driving mode from a plurality of driving modes associated with the vehicle;
determining a driving profile in the selected driving mode associated with a user of the vehicle based on the sensor information;
updating values of mode parameters associated with the selected driving mode based on the driving profile; and
controlling, via at least one electronic control unit (ECU) of the vehicle, a plurality of functional components of the vehicle based on the updated values, wherein
each of the mode parameters has a predetermined range of values, the range of values being adjustable via a settable lower threshold and a settable upper threshold, and the updated values for each of the mode parameters are constrained to remain within bounds of the lower threshold and the upper threshold.
